(19) United States
(12) Patent Application Publication
(10) Pub. No.: US 2021/0133668 A1
(43) Pub. Date: May 6, 2021

(54) ON-DEMAND AND JUST-IN-TIME CUSTOMER FULFILLMENT BY AN AUTOMATED CONVENIENCE STORE SYSTEM AND METHOD

(71) Applicant: Flukebox Inc., Glendale, CA (US)

(72) Inventor: Grigori Mikayelyan, Glendale, CA (US)

(73) Assignee: Flukebox Inc., Glendale, CA (US)

(21) Appl. No.: 17/092,171

(22) Filed: Nov. 6, 2020

Related U.S. Application Data
(60) Provisional application No. 62/931,685, filed on Nov. 6, 2019.

(51) Int. Cl. G06Q 10/08; A47J 31/40

(52) U.S. Cl. CPC G06Q 10/087; A47J 31/407; G06Q 10/0836

(57) ABSTRACT

An automated convenience store system built as a standing unit within a modified industrial storage unit. The storage unit container machinery, electronics, access ports and hatches, power generation and distribution components to effectuate the preparation, packaging and delivery of selected goods to a patron. The automated convenience store system employing a process of selecting the item of interest, preparing it for delivery or pick up. The convenience stores system can also operate as a location of depositing objects such as recyclables, expired medications and the like. The convenience sore system also employing a drink dispensing system with a specialized cup designed to prevent spills and tampering. The convenience store system is also capable of communicating with robotic unit or drone units to effectuate delivery of items.

### PRIORITY CLAIMS AND CROSS-REFERENCE TO RELATED APPLICATIONS

This application is related to and claims domestic priority benefits, per 35 USC § 119(e), from U.S. Provisional Patent Application Ser. No. 62/931,685 filed on Nov. 6, 2019, the entire contents, of the aforementioned application, are expressly incorporated hereinto by reference.

### TECHNICAL FIELD

The present disclosure relates to the arena of automating convenience stores using a self-sustained pod, operated by robots allowing for an on-demand and just-in-time fulfillment of perishable and nonperishable goods.

### BACKGROUND

In our ever-changing modern world, there is an increased push to automate all processes. Whether that is automating office tasks, transportation, or banking, the public's appetite for on-demand and efficient services has been on the rise. There are many business-to-consumer based operations that implement an on-demand and automated service platforms. For example, some companies employ chatbots on their websites and/or automate telephonic systems to resolve garden variety consumer-based issues. These types of systems rely entirely on non-human intervention.

Other automated platforms also exist in people's homes. The rise of IoT (Internet of Things) devices readily employ automated rules. These devices may be thermostats, security surveillance systems, entry access systems and personal assistant systems. They allow the user to automate daily and mundane tasks such as adjusting environmental conditions (air, light), operating appliances (refrigerators and coffee makers), providing news and information regarding their household (to-do-lists, re-supplying one's pantry, alerting of mail, unlocking doors etc.).

Even further, the automated systems are proliferating in the consumer purchasing realm. Whether that is automating purchases of goods listed in one's interest list (e.g. Amazon's Pantry List) or having delivery of groceries and food provided by many on-demand services such as Uber Eats, Postmates, or Target's same day delivery service to Amazon Prime, and beyond. Combining on-demand services, such as a delivery system of consumer goods and groceries, has taken on another level with automated robots darting through residential streets in order to deliver those goods to the customer. For example, Kiva Systems (now Acquired by Amazon Robotics), Starship and Marble, automate food delivery to its recipients using robotic vehicles. Thus, eliminating the process of hiring a human driver to pick up one's ordered meal and delivering it to its recipient. Increasingly, this type of on-demand and delivery systems are pushing the boundaries of the human-to-technology integration architecture.

In light of such developments and integrations, another level of adaptation is needed with regard to the operations of the quintessential convenience store. The estimated global retail sales from convenience stores is projected to amount to $4.9 trillion by year 2022, which constitutes a 22% market share of all retail sales activity. In the United States alone, the gross retails sales of convenience stores were $654 billion in 2018. Grocery sales amounted to about $240 million which is projected to be between $200 billion to $700 billion by year 2026. A study conducted by Coca Cola Research Council also indicates that primarily, patrons are drawn to convenience stores that are a short distance from their location and also those that allow for a speedy service. Those indicators are thus the best metrics used in determining the success of the convenience store. This is especially true for the millennial demographic which prefers a “grab and go,” “on-demand” and “gig-economy” lifestyle.

Furthermore, increase in population size, limited availability of commercial real estate within proximity of where people reside, as well as shortage of labor globally would adversely affect the growth of the convenience store industry. Given that opening a convenience store and operating them require a lot of upfront capital, around the clock working corps, risk of theft, risk of disposing of unpurchased items, lack of compliance with laws limiting sales of regulated products such as tobacco and alcohol, and no reliable means of food delivery whether due to health reasons or otherwise, handicaps this industry.

Nevertheless, the convenience stores still follow the traditional model of operation. That is to say that a typical convenience store setup requires acquisition of a permanent physical space, building of structure upon the space and stocking it with limited perishable and non-perishable goods that are frequently used by the average consumer. By limiting the variety of the goods sold, a convenience store can take up a small footprint. However, the convenience store has to be operated and ran by people. The putative patron has to physically interact with the convenience store and the operators inside it in order to obtain the goods that he/she desires.

Because of this limitation, no system has been conceptualized which allows such a consumer to order what he/she needs over the internet, have it prepared as he drives up to the convenience store to pick it up (or have it picked up and delivered by another), have a routine product(s) set for order and pickup/delivery, have a notification based system of informing the patron when items are sorted and ready for pick up, have an automatic transaction system for making the purchases, eliminating excess physical space, reducing the carbon footprint by employing low energy and efficient technologies, implementing artificial intelligence and machine learning robotic systems for dispensing proper goods of items, eliminating the need to man the automated convenience store, automatic re-stocking and re-shelving of products, limiting food spoilage and food borne illnesses, dispensing customer specific hot beverages while guaranteeing it does not become tainted upon transport or spills upon transport and finally, allowing for the owner of such a system to re-deploy it from one location to another and scale up/down as necessary.

### SUMMARY

The present disclosure relates to but is not limited to a staff-less and fully-contained, around the clock, on-demand, just-in-time, mobile convenience stores that are powered and operated on an automated basis.

An embodiment of the disclosure envisions a shipping container outfitted with a series of robotic arms, pneumatic manipulators, conveyor belts, shelves with lifts, climate-controlled compartments, containers, power generation unit, electronics, communication systems, connection port and the platform that connects all the components together.

The disclosure is broadly divided between the physical structure which contains the system in place to house and dispense the goods which consumers order, the platform that allows for interconnectivity of the system with the user-base which also carries on the automated features of the physical structure, and the tamper proof beverage cup.

In one embodiment, the container is a typical storage container that is repurposed to maintain a climate-controlled environment. It is coated and sealed against the elements, making it waterproof. The container may be equipped with refrigeration units and heating units to provide the proper temperature for perishable goods. Heating elements such as a microwave or oven may be used to heat up food just before dispensing it to the patron. A refrigerator unit may be used to keep food items in a cool or frozen state to ensure a longer shelf-life. Moreover, a dry compartment may also be integrated to keep some items moisture free at an ambient temperature.

A typical container would have a facade that faces the consumer. The back side would have access ports for maintenance people to ingress/egress and for distributors and pick-up personnel to regularly supply the container or pick-up items as necessary. The back side can contain the necessary access panels for utility connections. The container can incorporate a series of solar panels on top of its structure with tracking and charging electronics to power the unit on a self-sustained basis. The tracking capabilities would monitor the sun's movement and follow it in order to maximize the amount of sun the panels can capture and in return, convert into electricity. To provide power throughout the night and at times where there is overcast, the container can be installed with batteries to store power. Additionally, the container may be connected to the power grid in cases where the container's power reserves are inadequate to power the machinery and the whole system and/or to sell excess power back to the power company.

The container uses very efficient appliances, electronics and lighting equipment to ensure that the solar panels and batteries are able to maintain a steady power supply and round the clock uptime. Because the container is virtually sealed from the outside environment, and efficient lighting such as LED (Light Emitting Diodes) technology is used for illumination (both inside and out), the container may use little power to operate the electronics housed inside it. The lighting system may be controlled and adjusted by circuits which detect the ambient lighting conditions surrounding the container. Furthermore, the container may have high grade insulation so that the climate control electronics do not have to work overtime in order to keep it cool, dry, and/or warm. The container can also have multiple sensors to control the ambient temperature and/or the cooling, and heating compartments.

The container may incorporate antennas, wireless equipment and telecommunication capabilities in order for the system to be accessible to patrons who may be using, for example, smartphones, computers, tablets and the like. Furthermore, the container may integrate GPS sensors to keep track of where the containers are deployed and provide a marker for patrons navigating towards the containers. Thus, the containers may be transportable and re-deployable in areas where the need may change based on the population density, population flow, on certain events or the general conditions of the area.

In some embodiments, the container's facade can be made of glass or secure plexiglass whereby the patron can observe the inner workings of the unit and request products when on site. At each end of the container, facing towards the consumer, there can be a check in, drop-off, or a pick-up location. At a pick-up location, a typical consumer can request the goods it requires through the interface which may be based on a voice recognition system. The voice recognition system can employ NLPs (Natural Language Processors) to discern patterns in a speech and control the functionality of the system. In other embodiment, the pick-up location may incorporate a touch-based interface and a camera with facial recognition software to allow for authentication of the user and/or compliance with legal regulations. The pick-up location can also have a compartment that opens up when a user verifies its purchase and identity and access is granted so that the consumer can pick up their item(s). Authentication may be conducted via a smartphone, smart watch, use of log-in credentials, and/or a government issued identification card.

The drop-off location may contain a compartment that is also activated once a user's information is authenticated. A trap-door, or the like, may be implemented to allow the user to drop-off items such as their recyclable materials, expired prescription drugs, mail, shipping packages or the like. Depending on the item deposited, the container system has the ability to sort and safely route the item to its intended location for safe keeping. Recyclable items in the recycling bin, slated for compression, and then for collection by the pickup personnel. Shipping items to be sorted into the shipping bin. Expired prescription medication sorted and routed into proper waste disposal containers for collection. Furthermore, the check-in counter may be a separate location or combined with the previous two locations. The check-in counter may be used to deposit funds, withdraw funds, obtain lottery tickets, pay bills, pay for purchased items, verify/identify and to be authenticated and the like. Similar type of interfaces and or authentication fail-safe scenarios can be employed at the check-in counter.

In some embodiments, the container can have security cameras, shock sensors and necessary alarms installed on the unit to ensure that vandals and thieves are deterred and security of patrons is ensured. In some embodiments, in and around the facade and or the pick-up location, there can be advertisement space for rent by the public. Those spaces may incorporate monitors, screens, or OLED (Organic Light Emitting Diodes) illuminations to depict the advertisement to the public.

In some embodiments, the software architecture can allow the patron to place an order over the phone, via a smartphone app, a tablet, computer or a voice assistance unit, and an IoT unit installed on an appliance or the like. Furthermore, the patron can input its order at the check-in location and/or the pick-up or drop-off location. It is also envisioned that a patron can pre-select a list of goods it wishes to purchase or re-stock from time to time. Those purchases may be fulfilled on an automated basis and a notification can be sent to the patron for pick up. Furthermore, the identified list of goods may be sorted, packed and ready for pick up as soon as the patron is within the vicinity of the container. The container thus can utilize geocaching technology and perimeter monitoring technology to determine when its patrons are nearby for pick up.

In another embodiment, the patron can be notified of current offers that a container has with individual products or bundled products that are possibly on sale or discounted. Thus, in such a case, the patron may be driving nearby a container(s) and a pop-up will inform him/her of those occurrences. Furthermore, the patron's agent may send an order to the container which will alert the patron once its package is ready for pickup.

In another embodiment, the software architecture may have some promotional and or subscription-based plans available for patrons whereby on a regular basis, they are alerted of goods they may be interested in picking up. With that regard, artificial intelligence and machine learning algorithms can be employed to discern from the patron's purchase patterns or from the purchasing patterns of the local demographic. From statistical analysis, the software architecture may recommend certain items for the patron to purchase.

The robotic, pneumatic, shelf-lift, and conveyor belt system that are considered the mechatronic segment of the container operate on an automated basis. The robotic arms may be designed to allow for enough degrees of freedom to access the items stored on the shelves. Thus, the robotic arm(s) may traverse in between the shelf-lifts as necessary. The robotic arms may have digits and/or suction cups to maneuver the products from the shelves and unto a basket and then ultimately unto the conveyor belt. The robotic arm(s) can also help with manipulating the product on the conveyor belt in at the packing and sealing section. The robotic arm(s) can also deliver the products to a lower section of the container towards the backside of the container or to a higher holding location close to the ceiling. Furthermore, the robotic arm(s) may be able to grab items deposited by a patron and properly manipulate it into the sorting bins through the use of the pneumatic manipulators, the conveyor belts and the shelf-lifts.

The robotic arm(s) can also incorporate a visual recognition system which can be used to make decisions on what product/item to pick for the patron, whether the product is in adequate shape for dispensing and or to aid the arm to properly function. The image processing engines may recognize patterns and classify them appropriately based on artificial intelligence and machine learning algorithms. For example, assume a patron has ordered a carton of milk and the robotic arm maneuvers to pick that item. Upon arriving at the shelf where the carton of milk is located, the image sensors and the image processing engine determines that the product is expired or leaking, it can properly discard the item and grab the next item which conforms to strict quality control measures.

In an embodiment, the robotic arm(s) can be utilized to re-stock the container. When the authorized personnel deliver new inventory to the container, through the access ports located behind the container, the robotic arm(s) can quickly help put the items in their proper shelves. A holding container can be designated for temporary placement of those goods as the robotic arm(s) maneuvers, recognizes the item, grab them and place them onto the shelves. Thus, the robotic arm(s) can serve the functions of dispensing products as well as re-shelving them.

In combination with the robotic arm(s), the pneumatic manipulators can nudge items from and unto the conveyor belt, the robot's basket and in the sorting bins. Pneumatic manipulators can have distance measuring and proximity sensors to detect items in motion and/or to avoid obstacles. The pneumatic manipulators can also be installed on the shelves where products may be stacked and organized. The pneumatic manipulators can help the robotic arm(s) in grabbing the product and/or it may push the item unto the robot's basket. Once the item chosen is on the conveyor belt, it may be transported to another section of the container for packaging and sealing into proper containers and boxes. In some embodiments, based on the item desired, it may be placed in a plastic bag. In other embodiments, the item may be vacuum sealed and/or heat-shrunk. In yet other embodiments, the item may be placed in a box, with or without padding or cushions.

The shelves can also be outfitted with lift systems to lower and raise products unto locations where it would be easier to display, dispose and to allow for the robotic arm and/or the pneumatic manipulators to pick and place the items onto the conveyor belt. In some embodiments, the shelf-lift systems can drop off an item directly unto the conveyor belt rather than utilizing the robotic arm(s).

In other embodiments, the shelf-lift system can work in tandem with the robotic arm(s) to lower a product unto a ground section slated for access by automatic delivery robots. The container can have a designated section near the interior wall facing towards the back end of the container. This section will have an automated door access where an authorized robotic vehicle can approach into to receive the product. The shelf-lift system and the robotic arm(s) can help place the product unto the robot's holding tank for secure delivery to the patron.

In another embodiment, the container can have an upper section closer to the ceiling where another access door can open and close for delivery of the product with the use of a drone. The shelf-lift system can push up the product towards the ceiling, slated for delivery. At which point, the access door can open and either pneumatic manipulator and/or the robotic arm(s) can help to place the item onto a drone pad. The access door can close at that point and an automated drone can fly and pick up the item slated for delivery.

The conveyor belt will feature lasers, speed and motion sensors, positioning sensors and weight sensors to properly route the product/item from one location to the other.

Once the product is put on or dropped off unto the conveyor belt, the product is moved to the packaging area. After packaging the product, it can travel to be pick up location for pick-up and/or deliver. If an item is deposited in the drop-off location, the conveyor belt with or without the help of the robotic arm(s) can carry it away for it to be discarded, sorted into the bins or re-shelved. The pick-up location can also have a dispensing shelf which uses a trap-door. The trap-door allows the patron to access the product housed inside the container. The trap-door may be operable using electronic servos, pneumatic/hydraulic components and the compatible sensors that allow for a smooth and safe operation. Furthermore, the same structure may be incorporated on the receiving shelf at the drop-off location, which also can use a trap-door access when a patron drops-off items such as mail, recyclables, etc. In conjunction, there can be an opening near the pick-up and drop-off location where drinks can be dispensed. Drinks that are both packaged and available for single use or where a nozzle can disperse the liquid in the patron's cup. Additionally, small frequently used items may also be dispensed such as gum, cigarettes, candy, etc.

In some embodiments, the conveyor belt can incorporate a hybrid conveying system. The first layer can be made of a flexible mesh section that can be engaged to transport a fragile object. The second layer can be made of a more sturdy and rigid material such as leather or rubber, and can be engaged for non-fragile products. The first layer can activate once the system recognizes what type of product is needed to be dispensed. The conveyor belt can then dynamically change the section where the product is located, from the second layer to the first layer. Then the product may be placed on that section or drooped unto that section for transport. The second layer works the same way except it is designated for non-fragile items.

The container can also contain a coffee and tea brewing station for patrons who desire those beverages. The coffee and tea brewing station can dispense the liquid in a container supplied by the patron or a proprietary package can be used instead. The proprietary package that is used in the container's brewing system is a completely sealed unit.

The brewing system is outfitted with a specialized liquid delivery system that brews the coffee/tea in one location. Then, through a delivery mechanism it is injected into a tamper proof and/or a thermo resistant (double-lined/single-lined) cup. The injection happens with use of a needle or nozzle that can fill a cup with the already brewed drink that may be pre-mixed with sugar, creme or other ingredients. The mixing takes place after the drink is brewed but before injection occurs.

The proprietary thermo resistant cup can structurally be completely sealed before any beverage is injected into it. The delivery mechanism can maneuver the needle or nozzle on top of the thermo resistant cup and can lower it to penetrate into the cavity of the thermo resistant cup. Then, the injection occurs at a rate adequate enough to allow air to escape. Alternatively, a secondary chamber inside the needle, which is somewhat offset, can serve as a means to vacuum out the excess air as the beverage is being injected. This is to ensure that the sealed thermo resistant cup does not explode as the liquid is deposited into it, which invariable increases the pressure inside the thermo resistant cup. Because the hole created by the needle/nozzle is very small, air has to escape from the same hole in some manner. In an alternate embodiment, the needle may puncture more than one hole, possible using multiple needles with varying diameters. Thus, one hole would be used to inject the liquid and the other for the air to escape. Alternatively, the thermo resistant cup can have a one-way vent incorporated unto its lid so that air can escape as it is being filled up with the liquid. The one-way vent can actually be made of some semi-porous material that allows only air molecules to pass but not molecules of water or of a like liquid.

After the cup has been injected with the liquid, the patron can tear open a tab on the lid and consume the product. Because the proprietary thermo resistant cup is virtually sealed from the outside world, the contents of the thermo resistant cup stays at a relatively static temperature. Combined with the thermo resistant construction of the cup, the liquid remains at the same temperature, as injected, for a long time. Furthermore, because the thermo resistant cup and its contents are virtually sealed and there is no lid to remove, they are tamper proof, virtually spill-proof and cannot be contaminated easily. Therefore, delivering products in the thermo resistant cups becomes more feasible in an on-demand, food/beverage delivery industry. The thermo resistant cups can also be utilized to serve chilled drinks. Due to the thermo resistant design, the contents of the thermo resistant cup remain unchanged regardless if the liquid is cold or hot.

In another embodiment, the liquid is injected in more traditional ways where the cup has an opening like traditional cups. Once the liquid is filled inside the cup, the liquid delivery system applies a properly sized cover and seals it shut by means of melting, thermal bonding, bending or clipping unto the cup.

In another embodiment, the container can be used to deliver both over the counter and prescription medication. With use of the robotic arm(s), pneumatic manipulators, the shelf-lift systems and the conveyor belt, medication can be organized and made ready for pick-up and/or delivery. It is envisioned that prescription processing of medication may done in an automated fashion. Whereby a patron can obtain a prescription of the medication from his/her medical professional, at which point that information can be relayed to the container with the software architecture. The physician or doctor issuing the prescription can directly send the prescription for fillings, directly to the software architecture which will determine where those medications are available for pick up by the patron or delivery to the patron. In another embodiment, the patron can scan the prescription by use of a digital camera integrated on his/her smartphone. The scan of the prescription will be automatically relayed to the software architecture's database that will automate the sorting, packaging and pick-up/delivery of the medication from a local container.

### BRIEF DESCRIPTION OF THE DRAWINGS

Embodiments in accordance with the present disclosure are shown in the drawings and will be described below with reference to the figures, whereby elements having the same effect have been provided with the same reference numerals. The following is shown:

FIG. 1 shows a schematic view of the convenience store system.

FIG. 2 shows a front-view of the convenience store system.

FIG. 3 shows a back-view of the convenience store system.

FIG. 4 shows a back and perspective view of the convenience store system.

FIG. 5 shows a front perspective view of the convenience store system.

FIG. 6 shows a front perspective view of the convenience store system.

FIG. 7 shows a perspective view of the inside of the transport container.

FIG. 8 shows a schematic-view of the liquid dispensing system.

FIG. 9A shows a side-view of the proprietary cup.

FIG. 9B shows a top view of the property cup's lid.

FIG. 10 a flow chart illustrating an embodiment of the convenience store system in dispensing mode.

FIG. 11 a flow chart illustrating an embodiment of the convenience store system in depositing mode.

FIG. 12 a schematic block diagram illustrating an embodiment of the convenience store system.

FIGS. 13-16 show another embodiment of the container specifically showing the mechatronic system, the robotic arms and the shelves.

### DETAILED DESCRIPTION

An embodiment of the on-demand and just-in-time customer fulfillment by an automated convenience store system is described herein. However, it will be clear and apparent to one skilled in the art that the disclosure is not limited to the embodiments set forth herein.

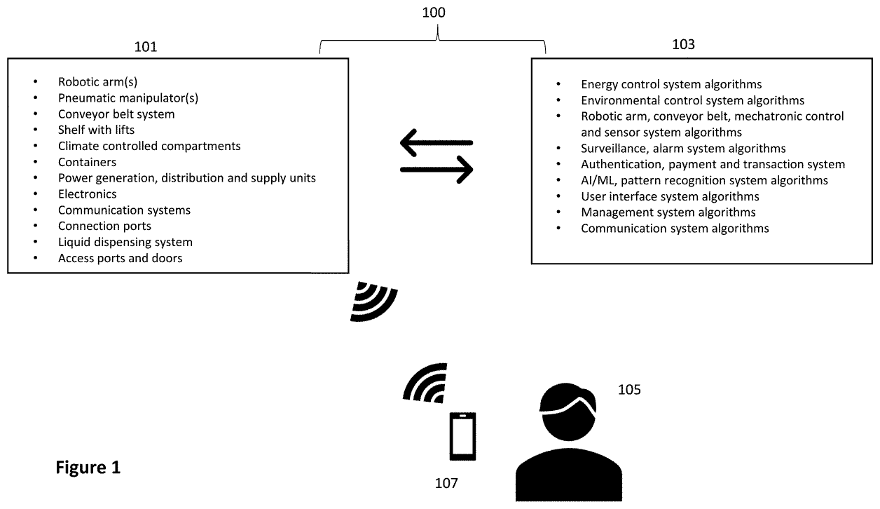

FIG. 1 shows a schematic view of the convenience store system 100 discussed herein. The container 101 houses the physical components of the disclosure (discussed at length below) such as the robotic arms, the pneumatic manipulators, the conveyor belt system, the shelf with the lift systems, the climate-controlled compartments, the sorting containers/bins, the power generation, distribution and supply system, the electronics, the communications system, the liquid dispensing system, the connection ports, access ports and doors. The container 101 is operated by the software architecture 103. Specifically, the software architecture 103 carries on the controlling and managing of the container 101 by interfacing with the energy control system subroutines, the environment control system subroutines, the robotic arm, conveyor belt, mechatronic control and sensors system subroutines, the surveillance camera, alarm system subroutines, the authentication, payment and transaction system subroutines, the Artificial Intelligence/Machine Learning (AI/ML), pattern recognition system subroutines, the user interface system subroutines, the management system subroutines, and the communication system subroutines.

A typical patron 105 interacts with the convenience store system 100 with use of a computerized interface such as a smartphone 107. The patron 105 can use any type of a ubiquitous device such as a notebook, laptop, smartwatch, tablet, smartphone, computer, traditional phone, IoT device, to enable communication between him/her and the convenience store system 100. The communication mode may be effectuated by a wireless medium and/or a wired medium depending on what communication interface the patron 105 is using. With wireless devices such as a smartphone 107, the patron 105 is likely to use a wireless medium and with a physically computer connected via a landline to the internet, which can implement a wired medium and/or a wireless medium. It is envisioned that the convenience store system 100 can maintain communication with the software architecture 103 via a wired or wireless medium. In any case, the container 101 is equipped with the necessary communication systems such as antennas, digital signal processors and control systems to enable such an eventuality.

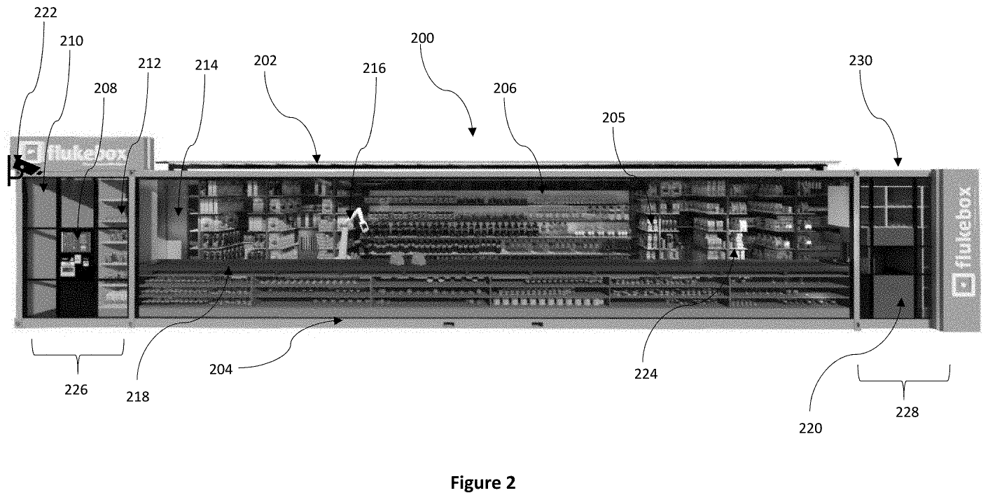

FIG. 2 shows a front-view of the convenience store system 200 that is made out of a transport container 204. The transport container 204 can be a storage container or a shipping container. The transport container 204 is repurposed and modified to be able to house electronics, mechanical components, power units, climate units, storage units, access ports and doors as well as perishable and non-perishable goods that are dispensed to the public. The transport container 204 typically measures 54 ft by 8.5 ft by 8 ft sizes of containers may vary depending on requirements. The facade of the transport container 204 has a center dominant area that is cutout and inserted with a transparent glass 214. The transparent glass 214 can be an acrylic glass, fiberglass such Plexiglass®. The transparent glass 214 is thick enough to provide for proper insulation, security and visibility. Furthermore, the transparent glass 214 can be coated with a UV (Ultraviolet) film in order to protect the contents from the sun's rays. The transparent glass 214 allows a patron to visually inspect the storefront and order his/her desired product.

The transport container 204 also has a back side (discussed below) which integrates personnel access door(s), delivery pick-up portal with authentication terminal, robotic unit access port(s) and other connection port(s). The personnel access door(s) are used for delivering of new items to the transport container 204 and or collecting items from it. The delivery pick-up portal is for delivery personnel to pick up a patron's 105 order. The delivery pick-up portal also integrates an authentication terminal or interface which allows the delivery personnel to verify its lawful purpose with its engagement with the convenience store system 200. The authorized personnel can gain access to the transport container 204 by opening the access door(s) and delivering the products into it. Then the convenience store system 200 will employ the robotic arm(s) 216, the pneumatic manipulators (not shown), the shelf-lifts 224 and conveyor belt 218 in order to restock the transport container 204. Furthermore, the robot unit access port(s) can be automatically operated to allow for ingress and egress into the transport container 204. When a robot comes close to a robot unit access port(s), the convenience store system 200 recognizes as an authorized vehicle with a series of handshakes and authentication measures (as discussed below). The convenience store system 200 thus can open the robotic unit access port(s) to let the robot in for loading of the items 205 and delivery of it to the patron. The other connection ports (discussed below) are also used as a means of connecting the convenience store system 200 to utility connections such as gas, water, power and communications.

The transport container 204 can have solar panels 202 distributed atop its roof. The solar panels 202 are used to capture the sun's energy and convert it into electricity. The solar panels 202 also have the ability to track the sun in order to maximize the amount of light it can capture and therefore convert into energy. Light tracking and motorized systems are integrated into allow the solar panels 202 to follow the path of the sun. The solar panels 202 are also connected to power generation and distribution electronic units in order to maintain an efficient use of the energy. These electronic units can also be connected to a series of batteries in order to maintain a constant flow of power throughout the night and at times of cloudy skies. Furthermore, the excess energy generated by the solar panels 202 can be re-sold to the power company if the convenience store system 200 is connected to the power grid.

The transport container 204 can also designate an area atop its roof for the purposes of landing and lifting off of automated drones. The drone pad 230 can be a section located next to the solar panels 202. Within the vicinity of the done pad 230, there can be an access hatch that can be operated by a motorized or pneumatic system. The access hatch can open and close in order for the shelf-lifts 224 to bring up the ordered items 205 and/or with the help of the robotic arm(s) 216, for placing those items 205 onto the rooftop, near the drone pad 230. Once the products are placed near the drone pad 230, the drone can fly in, land, and carry the items to its destination. The drones will invariably have the ability to grab or latch onto the items placed near the drone pad 230. The access hatch and the series of choreographed operations pertaining to the shelf-lifts 224 and the robotic arm(s) 216, can be automated once the drone is in close proximity to the transport container 204. Furthermore, the access hatch can only be opened by an authentication and security verification process between the drone and the convenience store system 200. Therefore, close communication systems such as Bluetooth®, NFC (Near Field Communication), and other wireless handshake processes are contemplated to effectuate such a verification system.

The transport container 204 is an environmentally efficient structure due to the proper insulation located within the unit itself. Because of the virtually sealed environment of the transport container 204, little energy is exchanged between the transport container 204 and the environment surrounding it. Furthermore, the transport container 204 expends judicious amounts of energy in order to keep a static climate inside the transport container 204. It is contemplated that certain areas of the transport container 204 can contain refrigeration units 206, dry areas, and heating areas. The refrigeration units 206 are intended to keep produce, liquids and other perishable goods in a cool state in order to prolong their shelf life. Furthermore, the dry areas are sections of the transport container 204 that are designated to keep some items in a static condition unaffected by humidity or temperature changes. Thus, the ambient temperature in those areas are highly regulated to keep a steady state. In other areas of the transport container 204, there can be heating elements or appliances meant to keep some items warm or even hot. For example, if a patron 105 is ordering a pastry for pickup and intends for it to be warm, the pastry may be routed to the areas that can activate the heating elements and/or the appliances in order to effectuate that goal.

Climate control sensors and thermostats are interspersed within the transport container 204 in order to constantly monitor the state of the climate inside the transport container 204. This monitoring and adjusting of the temperature along with the efficient use of energy and the efficient construction of the transport container 204 aids in significantly reducing the energy use of the convenience store system 200. Combined with the fact that illumination within the transport container 204 is provided by means of efficient LED panels, the convenience store system 200 can be sustained by battery power only.

The convenience store system 200 can have telecommunication capabilities with the use of digital signal processors, antennas and other communication hardware to effectuate the connectivity between the patron, the convenience store system 200 and/or the software architecture. Additionally, in some embodiments, the transport container 204 may have a Global Positioning System (GPS) transceiver installed on it in order to track movement of the transport container 204. Moreover, the GPS capability can be used to provide a marker for the putative patron to navigate towards. Sometimes it would be necessary to move the transport container 204 at a different location based on the conditions, thus, the GPS “beacon” can alert users where the re-located site is using the convenience store system 200 software interface. The software interface can be implemented through an online portal, a web application, downloadable software onto a laptop, computer or a mobile application.

The transport container 204 has a pick-up location 226 and a drop-off location 228. Alternatively, either the pick-up location 226 or the drop-off location 228 can be combined with a check-in location (not shown). The pick-up location 226 houses the POC (Point of Contact) interface 208. The POC interface 208 can serve many functions. For one, the POC interface 208 allows a patron to manually order items from the convenience store system 200. At other times, the POC interface 208 enables the patron 105 to purchase lottery tickets, pay bills, withdraw funds from the built-in ATM (Automatic Teller Machine) machines, and authenticate himself. The POC interface 208 is equipped with touchscreen(s), voice recognition systems, cameras with digital imaging processors to facilitate the human to technology interaction. In situations where the patron 105 is ordering highly regulated items such as tobacco, alcohol or medication, its authority to do so has to be verified. Verification can be done in a number of ways. For one, the patron's 105 identification card and or login credentials may be cross checked for access. Moreover, the patron 105 can authenticate its credentials using a smartphone, smart watch or a unique key identifier. The patron's 105 biometrics can also be used instead to effectuate the authentication using the digital cameras and the pattern recognition hardware operating it and/or the voice recognition system operating natural language processors as well as face ID of patron's 105 smartphone 107. In other embodiments, a combination of these authentication measures can be used to further limit the ability of spoofs in acquiring access to items they do not have the right to access. With regard to delivery personnel, their information can also be obtained and authenticated much with the same means. Their authority, as granted by the patron 105, can be relayed to the POC interface 208 via smartphone, unique temporary access codes, voice or signature verification, two factor authentication or the like. It is contemplated that the back of the transport container 204 may house an interface or a terminal much like the POC interface 208 to effectuate authentication of the delivery personnel. In other embodiments, the delivery personnel may be vetted through a public and private database to ensure his/her veracity in making the pick-up on behalf of the patron 105.

The POC interface 208 can have the ability to dispense items such as lottery tickets, money, goods as well as over the counter and prescription medications and drinks. The POC interface 208 has the necessary access doors that enable the convenience store system 200 to open/close sections of it to allow the patron 105 to retrieve the items 205 in question. In other embodiments, the drop-off location 228 can be utilized to effectuate pick-up of items 205 if they are bulky or if many patrons 105 are waiting for their turn at the convenience store system 200. Furthermore, the delivery pick-up portal in the back of the transport container 204 can be utilized by patrons 105 for pick up of their items 205 in case there is a long wait in front of the transport container 204.

The pick-up location 226 also contains advertising panels 210. The advertising panels 210 can be temporary placeholders for print advertisement and/or be made of a monitor or OLED panels enabling the display of dynamic advertising content being served remotely. The advertising panels 210 can also be located near the drop-off location 228.

The pick-up location 226 and/or the drop-off location 228 can also have a surveillance camera 222 installed near the locations to monitor the activity taking place in front of the transport container 204. The camera 222 can be used to collect evidence such as people's identity, their vehicle license plate information and the like, if a crime is committed in front of the transport container 204. Would-be criminals would otherwise be inclined to break into the transport container 204 unless some camera 222 units and/or alarm systems are used to secure the transport container 204. In some embodiments, the transport container 204 can incorporate alarm systems with break-in and shock sensors to make sure vandals and thieves do not deface the transport container 204 nor gain access to it.

At the pick-up location 226, the liquid dispensing system 212 may be housed. The liquid dispensing system 212 can dispense both cold and hot beverages. In another embodiment, the liquid dispensing system 212 can be installed near the drop-off location 228. Furthermore, the liquid dispensing system 212 can have premade drinks such as juice or soda in cans, bottles or cartons ready for pickup. The robotic arm(s) 216 may be used to effectuate handoff of those items to the patron 105 and/or for delivery. The liquid dispensing system 212 has a specific liquid injection system (discussed later). A series of pumps, hoses, pipes, reservoirs, needles and sealing/binding components make up the liquid dispensing system 212 as discussed below.

The transport container 204 also houses the robotic arm(s) 216 that aid the convenience store system 200 in displacing the items from and into the transport container 204. Furthermore, the robotic arm(s) 216 can be used to digitally manipulate the items 205 into the proprietary boxes. The robotic arm(s) 216 can be outfitted with human-like digits and/or suction cups in order to manipulate the items 205 located on the shelf-lifts 224. Furthermore, the robotic arm(s) 216 can use the integrated suction cups to grab and help assemble the collapsible boxes and packing materials for use in packing the items 205 into the packaging (proprietary boxes and packages). The robotic arm(s) 216 can traverse through the transport container 204 and locate the items 205 that were ordered by the patron 105 or its agent. The robotic arm(s) 216 are able to locate the desired items 205 with use of digital cameras located on the robotic arm(s) 216 and/or as strategically placed inside the transport container 204. The digital cameras capture the objects or items 205 and that data is fed into the pattern recognition software in order to determine what items 205 or objects are located in its path. The images captured can also be used to train the robotic arm(s) 216 to enable them in selecting undamaged versions of the items 205. This whole mechanism can be implemented by an AI/ML engine. The robotic arm(s) 216 can also be used to sort and route objects or items 205 dropped off by the patron 105 at the drop-off location 228 in the deposit bin 220. Some objects or items 205 such as recyclables can be sorted and deposited into smaller bins. Other items such as expired prescription medication can be sorted and deposited into hazardous bins. Yet other objects, such as shipping packages and mail can be sorted and routed into shipping bins. The drop-off location 228 can ultimately employ the same type of authentication and verification system as employed at the pick-up location 226. The cameras incorporated into the robotic arm(s) 216 and/or located within the transport container 204 can also help to identify expired or damaged goods. In one embodiment, the convenience store system 200 can thus identify items 105 that are either expired, near its expiration date or somehow damaged, and can notify patrons 105, located within some radius of the transport container 204, to order those items 205 at a discount. Thereby, efficiently disposing of those items 205 and not discarding them into the trash slated for destruction or for storage in composting piles. This efficient utilization of items 205 and shelf space makes the convenience store system 200 a more profitable venture.

Moreover, the robotic arm(s) 216 can be used to select and dispense over the counter and prescribed medication. A patron 105 can specifically order the medication they require and the convenience store system 200 can initiate for either delivery or pick up of those medications. It is envisioned that this interaction can also be automated such that the patron's 105 physician can send over the prescription unto convenience store system 200 database so that the patron 105 can pick up his medication. In other embodiments, the patron 105 may scan his prescription slip using his smartphone's app. The app will send that information to the convenience store system 200 and delivery and/or pickup of the medication will then ensue.

The robotic arm(s) 216 can work in tandem with the shelf-lifts 224. Some items 205 may require to be lowered closer to the robotic arm(s) 216, or possible it may be fragile for the robotic arm(s) 216 to handle. Thus, the shelf-lifts 224 can elevate or lower the items 205 for easy access. For example, if a robot is going to be delivering the item 205 to the patron 105, it will first have to pick up that item 205 from the back of the transport container 204. In which case, the shelf-lifts 224 can lower the item 205 closer to where the robot is waiting for its payload. The robotic arm(s) 216 can then pick the item 205 from the lowered shelf-lifts 224 and places it into the robot's container for delivery. In some embodiments, the robotic arm(s) 216 may have a basket installed on its base (discussed below) to enable it to collect a number of items 205 for each segment of its traverse. It may be desirable to select multiple items 205 from nearby shelf-lifts 224 and temporarily place them unto its basket before returning back unto the conveyor belt 224.

Furthermore, the shelf-lifts 224 can also operate without coordinating with the robotic arm(s) 216. In such a case, the items 205 of interest can be dropped right unto the conveyor belt 218. With some sturdy and rigid items 205, this may be a more efficient use of item selection than employing the robotic arm(s) 216. However, in certain instances it may not be desirable to just drop the items 205 from the shelf-lifts 224 unto the conveyor belt 218 itself. In some embodiments, the items 205 may be picked up by the robotic arm(s) 116 with or without the help of the shelf-lifts 224 and then placed unto the conveyor belts 218. Then the conveyor belt 218 can carry the item 205 to the final packaging and/or sealing area close to the pick-up location 226. The robotic arm(s) 116 then can apply the proper packaging such as providing padding in a box or placing the items 205 into a bag. Once the items 205 have been placed in their packaging, they are ready to be picked up by the patron, the delivery person and/or the delivery robot/drone.

The robotic arm(s) 116, can also be used to package the items 205 ordered by the patron 105. Once the items 205 have been collected by the robotic arm(s) 116, and temporarily paced into its basket, the packaging of the boxes or bags can ensue before stuffing the items 205 into the packaging. The robotic arm(s) 116 can use an array of sensors such as the video cameras and/or lasers to determine the size of the items 205 picked for packaging. Based on that information, the convenience store system 200 can determine which type of box or packaging would be sufficient to properly package those items 205. After that decision is made, the robotic arm(s) 116, with integration of its digits and/or the suction cups, can grab the proper box and/or packaging which is in a collapsed state. At which point the robotic arm(s) 116 can assemble the box and/or the packaging using preprogrammed guidelines or physical guiding structures installed unto the body of the robotic arm(s) 116. After assembling the box or the packaging, the robotic arm(s) 116 can properly place the selected items 205 into the box or packaging while using the laser sensors and the camera sensors to monitor placing of those items 205 into the box or packaging. After ensuring that all the items 205 are properly sitting in the boxes or packaging, the robotic arm(s) 116 can either seal the boxes or packaging or place it onto the conveyor belt 218 for transport to another location for sealing.

The convenience store system 200 also utilizes a sophisticated conveyor belt 218. The conveyor belt can run the length of the transport container 204 and/or in between the aisles where the shelf-lifts 224 are stationed. The conveyor belt 218 can feature lasers, speed and motion sensors, positioning sensors and weight sensors to properly route the item 205 from one location to the other. In some embodiments, the conveyor belt 218 can have certain sections that can transform into a rubber facing surface or a net-like surface. In some circumstances, if the shelf-lifts 224 are slated to drop a fragile object unto the conveyor belt 218, the section under and in close proximity of the item 205 in questions can transform into a netting surface. Once the item 205 is dropped unto the conveyor belt, the netting material will break the fall of the item and catch it without damaging it. In other instances, a rigid item may be selected to be dropped from the shelf-lift 224. In which case, those items 205 can be dropped unto the rubber facing surface of the conveyor belt 218 without any danger of the item 205 being damaged in any respect. Thus, the conveyor belt 218 may transform that section underneath and near the item 205 located on the shelf-lifts 224, from a net-like surface and into a rubber facing surface.

The dropping of items 205 can be effectuated by the shelf-lifts 224, or the pneumatic manipulators (not shown) installed unto the shelf-lifts 224. Some shelf-lifts 224 may employ pneumatic manipulators and others will not, depending on how frequently those areas of the transport container 204 may have a need for pneumatic manipulators.

The robotic arm(s) 116, the shelf-lifts 224, the pneumatic manipulators (not shown), and the conveyor belt 218 can be used in a collaborative way to operate movement of the items 205 within the transport container 204. Furthermore, these same components can be used to restock the transport container 204. Once the distribution personnel enters through the back of the transport container 204, he may place the necessary items 205 on a designated area. Then, the robotic arm(s) can collect the items 205 of interest and place them onto the conveyor belts 218 and/or on its basket for later delivery unto the shelf-lifts 224. Conversely, the distribution personnel can collect objects or items 205 that were dropped off by the patron 105 at the drop-off location 228 and into the deposit bin 220 or sorted into the bins with use of the robotic arm(s) 116, the shelf-lifts 224 and/or the conveyor belt 218.

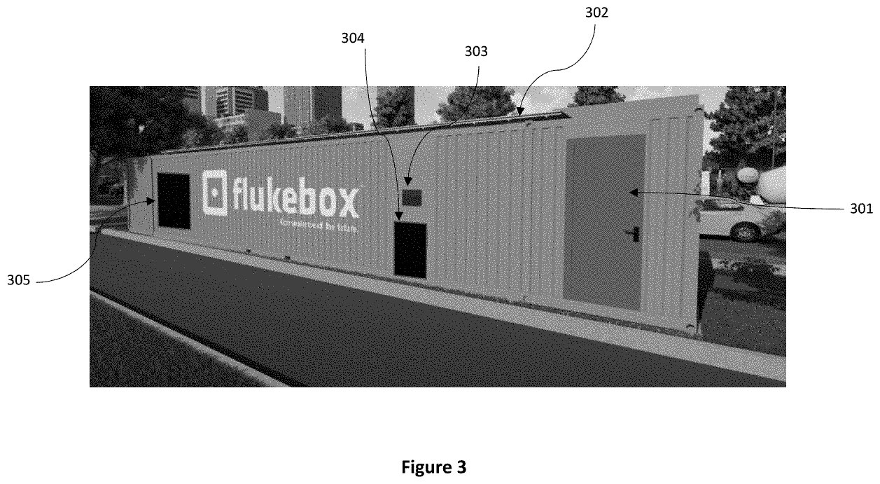

FIG. 3 shows a back-view of the convenience store system 200. The authorized personnel door 301 is shown which is used for ingress and egress. The authorized personnel can gain access through the authorized personnel door 301 once his identification has been verified. A terminal can be placed near the authorized personnel door 301 in order to effectuate the verification process. Alternatively, the authorized personnel can have his identity verified and access to the authorized personnel door 301 granted once he authenticates himself at the POC interface 208. The transport container 204 also has the solar panels 302 installed on its roof. Depending on the energy needs of the transport container 204, modular cells of the solar panels 302 can be added or subtracted as needed. The transport container 204 also incorporates the connection ports 303, which is a panel that allows the transport container 204 to be connected to utility supply lines. Utilities such as water, electricity, gas, and or communication can be connected through this interface. In another section of the transport container 204, the robotic access port 304 is installed to allow ingress/egress of the robotic unit that is designed to deliver items 205 to the patrons. The robotic access port 304 can be automatically operated by the convenience store system 200. Once the robot unit arrives at the robotic access port 304, the convenience store system 200 can verify the robotic unit. Verification can be effectuated by means of wireless communication channels and series of handshake processes as discussed above. Ne authority to egress is granted, the robotic access port 304 can open to allow the robot to enter. In another section of the transport container 204, the delivery pick-up portal with authentication terminal 305 allows for a delivery personnel and/or the patron 105 to authenticate his identity and pick up the items 205 ordered. The authentication terminal can be the same type as used in the front with the POC interface 208.

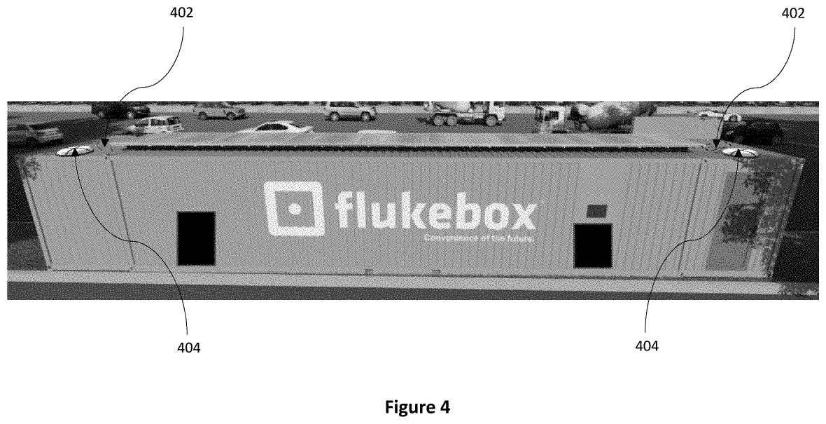

FIG. 4 shows a back and perspective view of the convenience store system 200 with the drone pads 404 incorporated on top of the transport container 204. In this rendition, two drone pads 404 are shown on either side of the transport container 204. In other embodiments, only one drone pad 404 can be designed. Near the drone pads 404, the access hatch 402 is enumerated. Once a drone lands unto the drone pad 404, the access hatch 402 can be used to deliver the intended item 205 for the drone to pick up. The access hatch 402 is automated and operated by the convenience store system 200. Once a drone's authorization to land and pick up items has been verified, with similar wireless methods and handshaking methods as used for the robot delivery stem, the access hatch 402 can automatically open. Once the access hatch 402 has opened, the series of robotic arm(s) 216, the shelf-lifts 224, the pneumatic manipulators, and the conveyor belt 218 can operate in tandem to route the item 205 unto the roof and near the drone pads 404. Once the item is delivered unto the roof of the transport container 204, the access hatch 402 can close and the drone can pick up the item 205 for delivery.

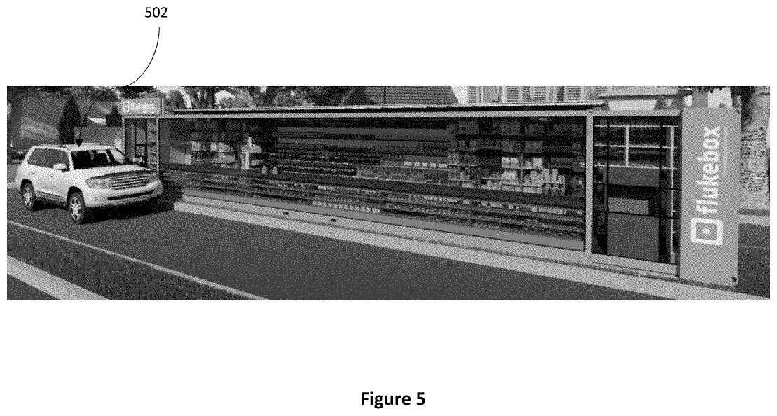

FIG. 5 shows a front perspective view of the convenience store system 200 where a vehicle 502 has arrived at the pick-up 226 location. As discussed above, the pick-up location 226 can serve both as a place of conducting the actual transaction, picking up items 205 or just verifying one's identity for authentication purposes.

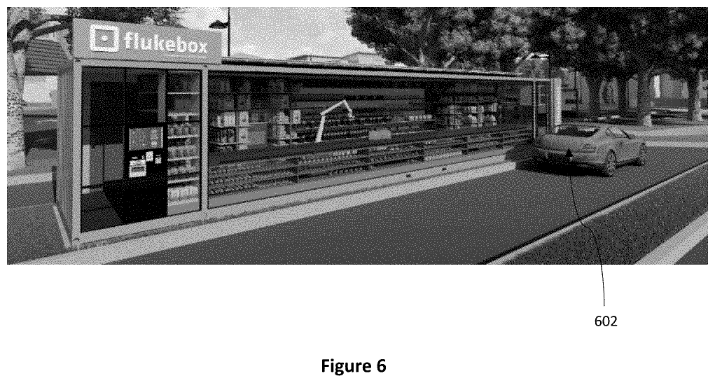

FIG. 6 shows a front perspective view of the convenience store system 200 where a vehicle 602 has arrived at the drop-off 228 location. There may also be a delivery driver pickup station in the back of the container. This helps ease the traffic, if there are other patron's picking up or ordering items 205. In such a scenario, the delivery driver does not have to wait and can pick up the items 205.

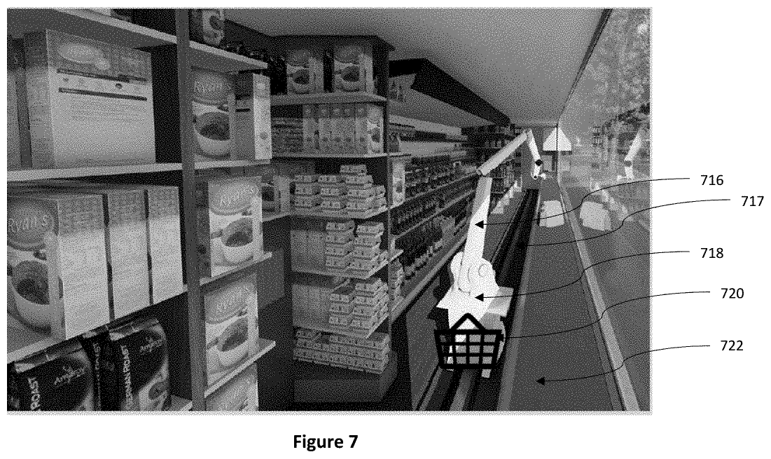

FIG. 7 shows a perspective view of the inside of the transport container 204. The robotic arm(s) 716 is shown attached to the robot driver 718. The robot driver 718 houses all the electronics and mechanics that allow the robotic arm(s) 716 to travel and manipulate its digits/suction cups. The robotic driver 718 travels on rails 717 that are interspersed throughout the transport container 204. The robotic drive 718 also has the robotic basket 720 attached thereon which allows the robotic arm(s) 716 to collect multiple items 205 and place it inside the robotic basket 720. The conveyor belt 722 is also shown in close proximity of the robotic arm 716 allowing for easy access.

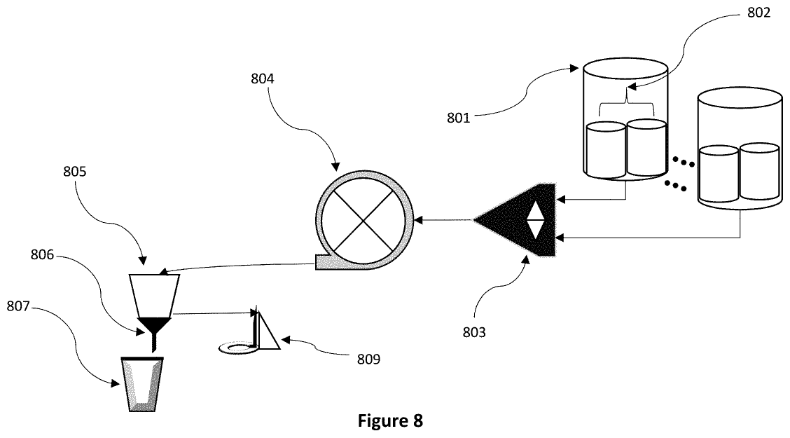

FIG. 8 shows a schematic-view of the liquid dispensing system 212 convenience store system 200. The drinks are housed in a series of reservoirs 801 and the compounds are housed in a series of containers 802. The reservoirs 801 can hold premade liquids such as water, coffee, tea, juice etc. The containers 802 can hold compounds such as sugar, cinnamon, creme, sweeteners, honey etc. The series of reservoirs 801 and the containers 802 will connect at the mixing and brewing station 803. The mixing and brewing station 803 can mix the allotted liquids and compounds together for as desired by the patron. The mixing may happen before some of the liquid is brewed and or at the same time as it is mixing with the compounds. After the mixing and brewing 803 finalizes its task, the liquid flows for the pump 804. The pump 804 provides pressure in order to inject the liquid into the proprietary cup 807. The liquid is forced into the injector 805 which in turn forces the liquid to go through the nozzle(s) 806. The nozzle(s) 806 is a thin hollow needle that allows it to puncture the proprietary cup's 807 lid (discussed below). The nozzle(s) 806 may be a series of needles offset at some distance. In other embodiments, the nozzle(s) 806 can be two different sized (diameter) needles. The multiple offset needles and/or the different diameter needles can be used to properly inject the liquid into the proprietary cup 807. Once the pressurized liquid flows from the nozzle(s) 806 into the cup 807, the air pressure inside the proprietary cup 807 will build up. That is because the proprietary cup 807 is completely sealed with its lid. Thus, the extra needle or the varying diameter needle can help in ejecting the trapped air so that the liquid can flow smoothly into the proprietary cup 807.

In another embodiment, a generic cup can be used instead of the proprietary cup 807. In which case, the same mixing, pumping and injecting process occurs and the liquid is delivered into the cup. However, the generic cup at that point needs to be closed with a lid. In which case a sealing unit 809 can be used to heat seal or melt a permanent lid unto the generic cup. The cup may travel some distance to be positioned under the sealing unit 809 or, the sealing unit 809 may travel to the location of the cup in order to provide the permanent lid.

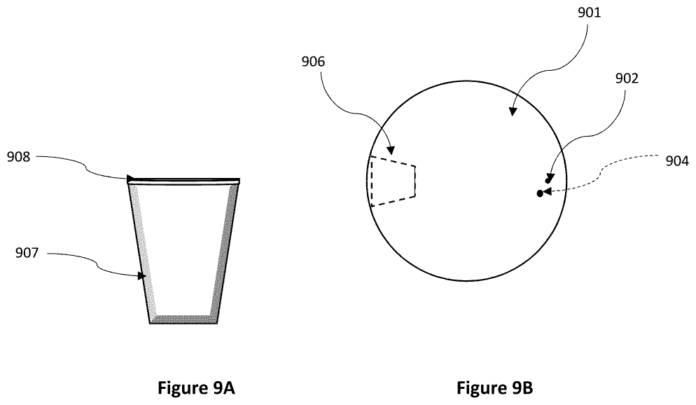

FIG. 9A shows a side-view of the proprietary cup 907 as discussed above. The property cup 907 also has a permanent lid 908 that is sealed and is tamperproof. Furthermore, the proprietary cup 907 has a thermo-shielded construction which keeps the beverage either hot or cold, depending on what the temperature of the liquid is inside the proprietary cup 907. Because the proprietary cup 907 is a completely sealed unit, delivery of beverages is effectuated with ease without the danger of a third party accessing the contents or contaminating the liquid inside. Moreover, because of the property cups 907 thermo-shielded construction, delivery of the beverage can be had with over long distances as the contents stay at a relatively stable condition. Finally, because the proprietary cup 907 is virtually sealed from the environment, even if the patron or the delivery personnel drops the proprietary cup 907, the liquids will not spill out or insignificantly compared to regular cups with traditional lids.

FIG. 9B shows a top view of the property cup's 907 lid 901. The permanent lid 901 is shown here with two puncture holes 902 and 904. The first punctured hole 902 was used to inject the liquid in the proprietary cup 907 and the second hole 904 was used as a hatch to dispel excess air. However, in another embodiment, the second hole 904 may not be necessitated as the nozzle(s) 806 can have multiple needles to both, inject the liquid into the property cup 908 and at the same time, but with another needle, vacuum out excess air. The patron ultimately can gain access to the contents of the liquid with the use of a semi-perforated lid opening 906. The lid opening 906 remains closed until the patron physically removes it to drink from the proprietary cup 907.

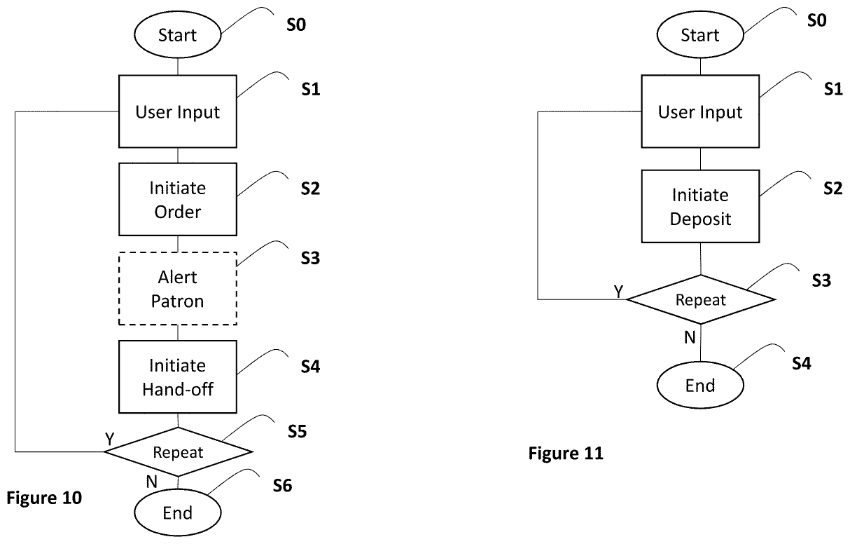

FIG. 10 shows the top down view of the software architecture 103 that implements the process of the convenience store system 100 when things are being dispensed. In step S0, the process starts by initializing the relevant subroutines. This may be initiated by the patron 105 using his/her a smartphone 107 that has the associated application to communicate with the convenience store system 100. Alternatively, the process can be initialized once the patron 105 is within some proximate range of the container 101. Because the patron's 105 location may be known to the convenience store system 100, the software architecture 103 can initialize the process when the patron is physically close to the container 101. Alternatively, the patron's 105 agent, such as his delivery person or a physician, can initiate the process by accessing the convenience store system 100 through their electronic device and/or portal. Moreover, the system can be initialized by the robotic unit or the drone which come into proximity of the container 101. Thus, the convenience store system 100 may be designed to be in low-power mode but passively “listen” for communication pings or handshakes in order to start and/or continue process of dispensing or receiving objects or items 105 at the container 101.

Once the process has initialized, the software architecture 103 steps through to the user input in S1. At step S1, the patron 105 has the opportunity to interact with convenience store system 100 using the software architecture 103. At certain times, the patron 105 can select the items 205 or things of interest they are interested in purchasing. The patron 105, can perform this selection process remotely, using for example a smartphone 107 device or another equivalent device. Additionally, the patron 105 can make selections while accessing the POC interface 208 of the container 101. The patron 105, or its agent, can also authenticate its identity with use of government issued identity cards, using biometric parameters, using log-in credentials, using electronic transponder units or other electronic devices such as a smartphone 107 or a smartwatch. With this regard, the surveillance cameras 222 or other digital cameras may be used to further verification and authentication process. Moreover, the robotic unit or the drone can authenticate by interacting with the POC interface 208 by the virtue of being recognized by the surveillance cameras 222. The interaction with the POC interface 208 can be in the form of passive handshakes rather than active measures of inputting information for authentication purposes. Wireless communication can be employed to implement such an interaction. Furthermore, the robotic authentication can be carried out in the back of the container 101, at or near where the robotic access port 304 is located. Likewise, the drone authentication can be carried out on top of the container 101, at or near where the drone pad 404 is located. Lastly, the authorized personnel or the delivery personnel can verify their identification at or near the authorized personnel door 301 or the delivery pick-up portal with authentication terminal 305, respectively.

After the S1, the software architecture 103 proceeds to initiate order at step S2. This step can enter into a number of subroutines. Some of these subroutines deal with the autonomous operations of the convenience store system 100 and some of it deals with the management of inventory and restocking. For example, a specific subroutine is dedicated to controlling the energy usage, climate control, lighting and communication between the patron 105, its agents, drones, robots, drones and the convenience store system 100. Another subroutine can be dedicated to managing the workflow of individual components and machinery located within the container 101. Another subroutine may be implicated with carrying on the packaging of items 205 chosen by a patron 105. Another set of subroutines may deal with identifying the item 205 of relevance, picking it and delivering it with the robotic arm(s) 216, shelf-lift 224, the pneumatic manipulators and/or the conveyor belt 218. Yet another subroutine may be in charge of carrying on the operations of filling up a drink or brewing a drink ordered by the patron 105 at the liquid dispensing system 212. Another subroutine can be in charge of maintaining integrity and security of the container 101 with use of for example the surveillance cameras 222.

In the case of the control subroutine, the convenience store system 100 can control power generation units such as the solar panels 202 in capturing the sun's energy. The subroutine can control the tracking of the sun rays as well as monitor the power output, conversion and storage of the electricity into the batteries. This subroutine can also determine whether excess generated energy can be diverted onto the grid, if the container 101, is connected to the power grid. In other circumstances, the level of energy use is also monitored to make sure if a spike in energy consumption is needed within the container 101, that deficiency of energy is supplemented by drawing it from the electricity grid. The subroutine can also manage wireless or wired communication within the container 101 and throughout the convenience store system 100. As patrons 105, their agents, delivery personnel, authorized personnel, robotic units and drones communicate with the convenience store system 100, this subroutine can handle the information exchange, authentication and handshakes of the system.

In the case of the management subroutine, the convenience store system 100 can control the flow of operations within the container 101. For example, when an item 205 is selected for dispensing, the robotic arm(s) 216 and the conveyor belt 218 may be supervised by the management subroutine. Additionally, restocking of the container, keeping real-time information about the inventory, and/or operating the authorized personnel door 301, the access hatch 402, and the access port 304 is carried out by the management subroutine. Moreover, any item 205 going out (dispensing) from the container 101, is handled by the management subroutine.

In the case of the picking subroutine, the convenience stores system 100 can control the individual electronics, the data flow, the sensor inputs output and the mechanical drivers or energizer components of the robotic arm(s) 216, the conveyor belt 218, the shelf with lift 224 and/or the pneumatic manipulators. For example, with the robotic arm(s), the image processors are utilized to determine the items 205 of interest that the patron 105 has ordered for pickup or delivery. The picking subroutine controls the capture, processing and object detection while the robotic arm(s) 216 is in motion. With regard to the conveyor belt 218 operation, the picking subroutine uses sensor information and data flow from other components in the convenience store system 100 to activate either the first layer or the second layer. In case a fragile item 205 is selected for packaging and delivery, the first layer can be initiated along the conveyor belt 218. In case the item 205 is a rigid one, the second layer can be initiated along the conveyor belt 218. These operations are all controlled by the picking subroutine.

The convenience store system 100 can control the packing of the items 205 selected with the use of the packing subroutine. Various sensors such as video cameras or lasers can be called upon with use of the packing subroutine in order to effectuate packaging of the items 205. The packing subroutine can supervise the preparation and packaging of items 205 with use of the robotic arm(s) 216 and the conveyor belt 218 or through some other means. For example, the packing subroutine may control vacuum sealing and/or heat shrinking components to properly pack and seal items 205 slated for delivery and pickup.

The liquid dispensing and preparation subroutine of the convenience store system 100 carries on the duties of operating the liquid dispensing system. The subroutine interfaces with sensors and electronic controllers and/or drivers to mix the drinks, brew the drinks, add things such as sugar, spices, crème etc. Furthermore, the subroutine also controls the pump and the injection nozzles to deliver liquid in the cup and/or seal the cup after the cup has been filled. That said, the subroutine monitors and controls the reservoir 801, the individual containers 802 and their functions, the mixer 803, the pump 804, the injector 805 and nozzles 806, the moving and aligning of the cup 807 and sealing the lid 809 shut.

The security and alarm subroutines of the convenience store system 100 monitor the premises with the use of sensors such as a camera 222 or shock and vibration sensors. By monitoring and reporting the conditions of the convenience store system 100, the subroutine can alert authorities of any impending dangers. In case a vandal or a thief approaches the container 101 and proceeds to vandalize or gain unauthorized entry, the cameras 222 and the various sensors can capture that information and initiate the alarm and or other safety measures. These operations can be conducted in tandem with the control and/or management subroutines. The cameras 222 can perform object detection and authentication to determine whether the person within the vicinity of the container 100 has benign or malicious endeavors.

At step S3, the software architecture 103 can optionally notify the patron 105 of an impending pickup or delivery of the item 205. If the convenience store system 100 has already picked, packaged or prepared the item, the software architecture 103 will alert the patron 105 that the item is ready for pickup or delivery. Furthermore, the notification system can periodically or occasionally notify patrons 105 within the vicinity of the container 101 when possible discounts or deals are available at that location. This step may be optional and the process is not limited to necessarily incorporating this function in this embodiment.

At step S4, the software architecture 103 can initiate handoff by dispensing items 205 or objects that the patron 105 is interested in. In this process, the dispensing subroutine of the container system 100 carries on the duties of actually relaying the item 205 ordered by the patron 105 to the pick-up area 226 or the areas dedicated for the robotic unit to pick up the item and/or the drone to carry it off. Furthermore, the subroutine is also in charge of dispensing for example cash from an ATM, prescription medications, lottery tickets, and already prepared drinks. Furthermore, the dispensing subroutine also receives information from the other subroutines, from step S2, in order to coordinate the process of dispensing items 205 and/or things. With that in mind, the dispensing subroutine can receive sensor information or user entered information that has been verified and authenticated before it controls the machinery and electronics to dispense the relevant goods.

At step S5, the software architecture 103 prompts the patron 105 and/or its agent and/or the delivery personnel to make other selections. If further selections are needed or further transaction needs to be carried out, the process is routed to S1 where the flow of the process restarts. Thus, the function block follows the “Y” for “yes” flow channel. However, if the patron does not require any further interaction with the convenience store system 100, the software architecture 103 ends the operation at step S6. Thus, the function block follows the “N” for “No” flow channel.

FIG. 11 shows the top down view of the software architecture 103 that implements the process of the convenience store system 100 when things are being received. In step S0, the process starts by initializing the relevant subroutines. This may be initiated by the patron 105 using his/her a smartphone 107 that has the associated application to communicate with the convenience store system 100. Alternatively, the process can be initialized once the patron 105 is within some proximate range of the container 101. Because the patron's 105 location may be known to the convenience store system 100, the software architecture 103 can initialize the process when the patron 105 is physically close to the container 101. Alternatively, the patron's 105 agent, such as his delivery person or a physician, can initiate the process by accessing the convenience store system 100 through their electronic device and/or portal. Thus, the convenience store system 100 may be designed to be in low-power mode but passively “listen” for communication pings or handshakes in order to start and/or continue process of dispensing or receiving things at the container 101.

Once the process has initialized, the software architecture 103 steps through to the user input in S1. At step S1, the patron 105 has the opportunity to interact with convenience store system 100 using the software architecture 103. At certain times, the patron 105 can select the items 205 or things of interest that the patron 105 is interested in depositing. The patron 105, can perform this selection process remotely, using for example a smartphone 107 device or another equivalent device. Additionally, the patron 105 can initiate these requests while accessing the POC interface 208 of the container 101. The patron 105, or its agent, can also authenticate its identity with use of government issued identity cards, using biometric parameters, using log-in credentials, using electronic transponder units or other electronic devices such as a smartphone 107 or a smartwatch. With this regard, the surveillance cameras 222 or other digital cameras may be used to further the verification and authentication process. The interaction with the POC interface 208 can be in the form of passive handshakes rather than active measures of inputting information for authentication purposes. Wireless communication can be employed to implement such an interaction. The interaction and authentication process can be effectuated either at the pick-up 226 location or the drop-off location 228.

After the S1, the software architecture 103 proceeds to initiate deposit at step S2. This step can enter into a number of subroutines, as discussed above. One subroutine that carries out the depositing process is the deposit subroutine. The deposit subroutine controls the flow of items and objects dropped-off in the drop-off location 228. The subroutine can implement information and data flow from other subroutines, as discussed above, to effectuate the intake of such items, sorting of such items and storing of such items. Moreover, after a particular bin that has been filled to its capacity, the management subroutine can initiate for authorized personnel to come and empty the affected containers or bins. The dispensing subroutine may be used to process receipt of money, expired medications, payment of bills, recyclables, returned items 205 and the like.

At step S3, the patron is prompted to restart the process of the software architecture 103, or end the transaction at step S4. Thus, the function block follows the “Y” for “yes” in the affirmative option and “N” for “No” for the negative option of the flow channels.

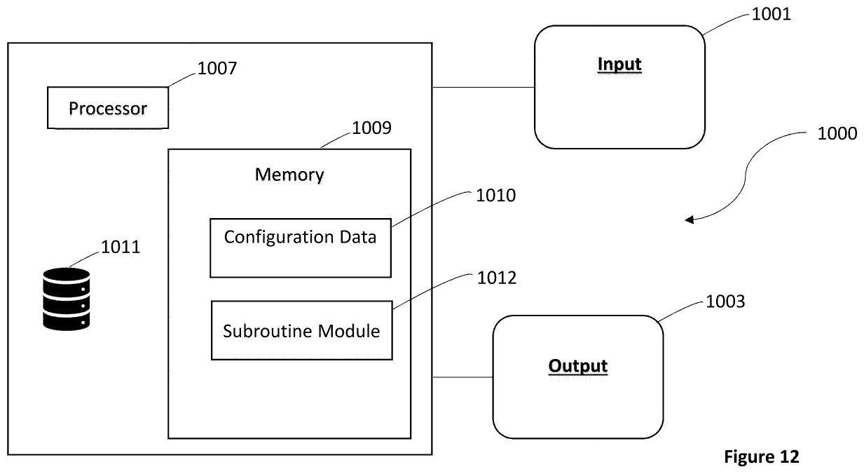

FIG. 12 shows a detailed block diagram of processing circuit 1000 for completing the systems and methods of the present disclosure is shown according to one embodiment. Processing circuit 1000 is generally configured to accept input 1001 from a communications device and or a patron 105. Processing circuit 1000 is further configured to receive configuration and preference data from the convenience store system 100. Input data may be accepted continuously or periodically. Processing circuit 1000 uses the input data to control and manage the preparation, dispensing, delivery and depositing of items or goods. Based on the desires of the patron 105, the processing circuit 1000 instructs the mechatronic components of the convenience store system 100 to automate the process of picking items, packing them and routing them to the target areas such as the pick-up location 226 or the various hatches and doors for the robotic unit or the drone to complete delivery. Processing circuit 1000 also controls the energy usage of the container 101 and adjusts the environmental controls within the various zones of the container 101. Processing circuit 1000 also facilitates the communication to and between the convenience store system 100 and the patron, its agent or the delivery mechanism (robot, drone). Furthermore, the processing circuit 1000 facilitates the validation and authentication of the patron 105 or its agent and controls management of inventory and restocking of the container 101. Processing circuit 1000 may generate notifications or warnings to be transmitted to a patron 105 throughout the order preparation process. Furthermore, the notifications or warnings may also be communicated to proper authorities in case of theft or criminal activity. In controlling and maintaining the convenience store system 100, the processing circuit 1000 may make use of machine learning, artificial intelligence, interactions with databases and database table lookups, pattern recognition and logging, intelligent control, neural networks, fuzzy logic, etc.

According to one embodiment, processing circuit 1000 includes processor 1007. Processor 1007 may be implemented as a general-purpose processor, an application specific integrated circuit (ASIC), one or more field programmable gate arrays (FPGAs), a digital-signal-processor (DSP), a group of processing components, or other suitable electronic processing components. Processing circuit 1000 also includes memory 1009. Memory 1009 is one or more devices (e.g., RAM, ROM, Flash Memory, hard disk storage, etc.) for storing data and/or computer code for facilitating the various processes described herein. Memory 1009 may be or include non-transient volatile memory or non-volatile memory. Memory 1009 may include database components, object code components, script components, or any other type of information structure for supporting the various activities and information structures described herein. Memory 1009 may be communicably connected to processor 1007 and include computer code or instructions for executing the processes described herein (e.g., the processes shown in FIGS. 1, 10, 11).

Memory 1009 is configured to receive a data stream from a communications device (e.g. smartphone 107, etc.) through input 1001 or a database 1011. For example, the data may include a real-time stream of networking data, packets, order related communication data. The data received through input 1001 may be stored in the memory 1009 until the processor 1007 is ready to access data.

Memory 1009 further includes configuration data 1010. Configuration data 1010 includes data related to processing circuit 1000. For example, configuration data 1010 may include information related to interfacing with other components (e.g., control subroutines, management subroutines, etc.). This may include the command set needed to interface with a computer system used transfer user settings or otherwise set up the system. This may further include the command set need to generate graphical user interface (GUI) controls, menus, and visual information. As another example, configuration data 1010 may include the command set needed to interface with components of communications device (e.g., a universal serial bus (USB) interface, a Wi-Fi interface, an Ethernet interface, etc.). Based on data stored in configuration data 1010, processing circuit 1000 may format data for output via output 1003 to allow a user to configure the systems as described herein. Processing circuit 1000 may also format data for output via output 1003 to notifications and warnings to be transmitted to a patron 105. Processing circuit 1000 may also format visual information for display on a POC interface 208 or a display device. Processing circuit 1000 may also format audio data for output. Configuration data 1010 may further include information as to how often input should be accepted from a communications device. Configuration data 1010 may include default values required to initiate the automated picking and packing of items 205 and to initiate communication with sensors or peripheral systems of the convenience store system 100. Configuration data 1010 further includes data to configure communication between the various components of processing circuit 1000.

Processing circuit 1000 further includes input 1001 and output 1003. Input 1001 is configured to receive a data stream (e.g., a digital or analog stream of data), configuration information, order information and preference information. Output 1003 is configured to provide an output to a POC interface 208, or a display device, to output data to a patron 105 via a networking protocol or direct communication with the POC interface 208, and to output data to components of the systems as described herein. Furthermore, the output 1003 can send information and data signals to the necessary electronic components to effectuate the ordering, packaging and delivery of the items 205 within the container 101.

Memory 1009 further includes the subroutine module 1012 for executing the systems and methods described herein. The subroutine module 1012 is configured to receive input data, order data from a communications device, configuration information, preference data, and other data as provided by processing circuit 1000. The subroutine module 1012 is generally configured to receive a remote order, process an order, schedule and pickup, provide feedback/notifications to a patron, authenticate a transaction, monitor security, manage and control energy, operate the climate and facilitate the item and/or drink dispensing from the container. The subroutine module 1012 may be further configured to operate according to an operator's preferences. In this manner, notifications and warnings provided to patrons, and values related to automate item ordering and/or preparation of liquids (e.g., order limits, hours of operations, list of ingredients etc.) may be adjusted according to the operator's desires.

The processing circuit 1000 can also have a database 1011 which can house a list of items that are available for dispensing and delivery. Furthermore, the database 1011, can be located at a central remote location which can house information pertaining to more than one container 101. The database 1011 can be accessed by the processor 1007 through the memory 1009 to determine if an order placed by a patron 105 can be fulfilled by that particular container 101. If fulfillment is not possible due to low inventory, malfunction or otherwise, the database 1011 can be updated using the subroutine module 1012.

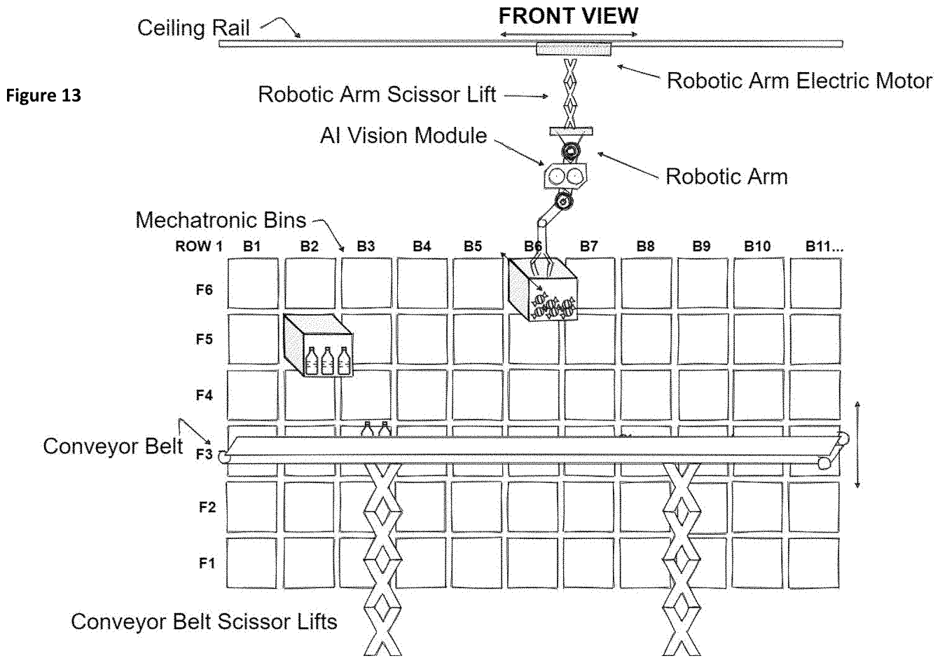

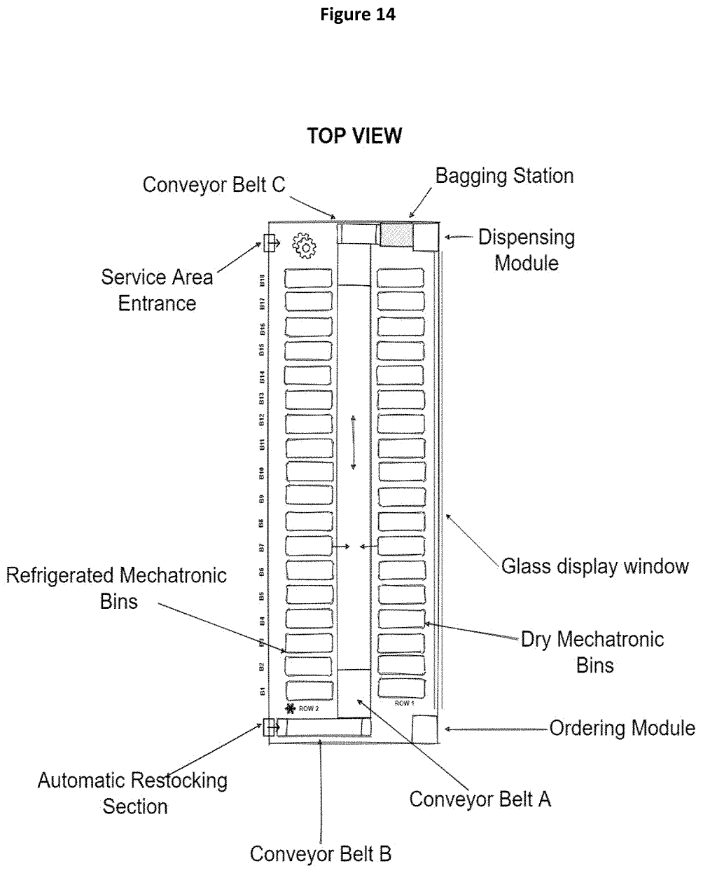

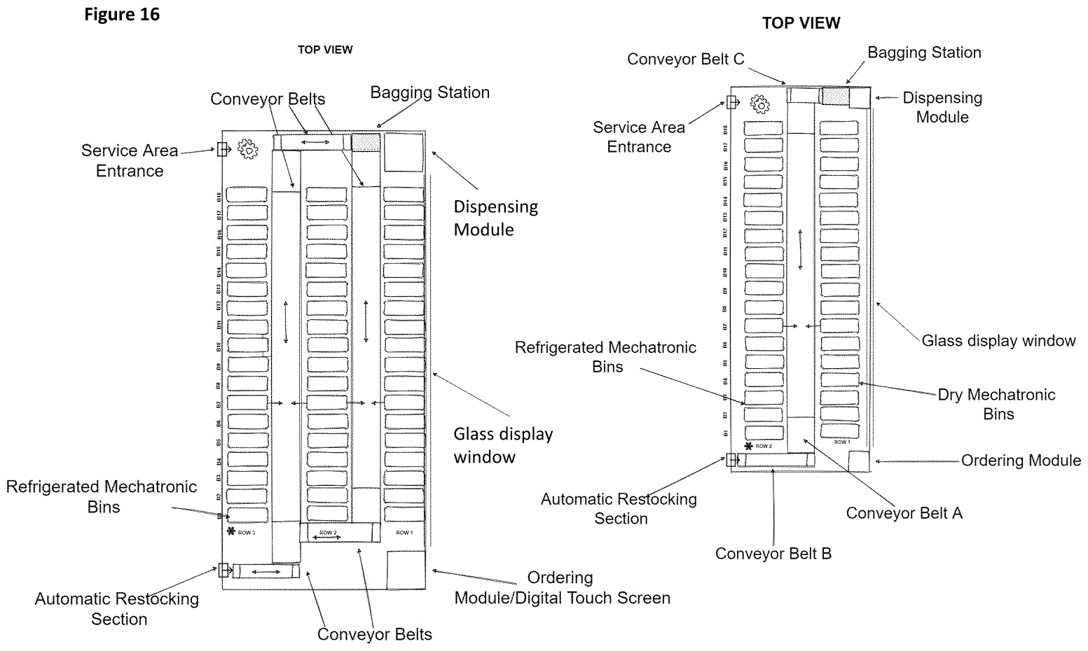

In another embodiment, shown in FIGS. 13-16, the container has hundreds of mechatronic bins that open and close automatically as well as three conveyor belts (A-C) and robotic arms that pick, pack, and dispense consumer products upon ordering. The container convenience store can have two configurations, large and small. Large size comes with three mechatronic bin rows and two conveyor belts, small size comes with two mechatronic bin rows and one main conveyor belt in the middle as shown in FIG. 16. There can be two types of bins, dry and refrigerated. Refrigerated bins carry cold drinks and other refrigerated consumer products.

All mechatronic bins have built-in electric motors that assist the opening and closing process. Refrigerated bins have a central cold air ducts that assist the flow of the cold air into the bins when they are in a closed position. Refrigerated bins also have an attached rolling covers that help contain the cold temperature inside bins. There are total of three conveyor belts built into the container. Main conveyor belt (A) is situated in the middle between the mechatronic bins as shown in FIG. 13. This is the main conveyor belt that transports consumer products to the packaging section at the end of the container. Conveyor belt (B) is utilized to move restocking bins inside for further restocking process. Conveyor belt (C) is utilized to move consumer products picked by the robotic arm into the packaging/bagging section for further dispensing as shown in FIGS. 13-15.

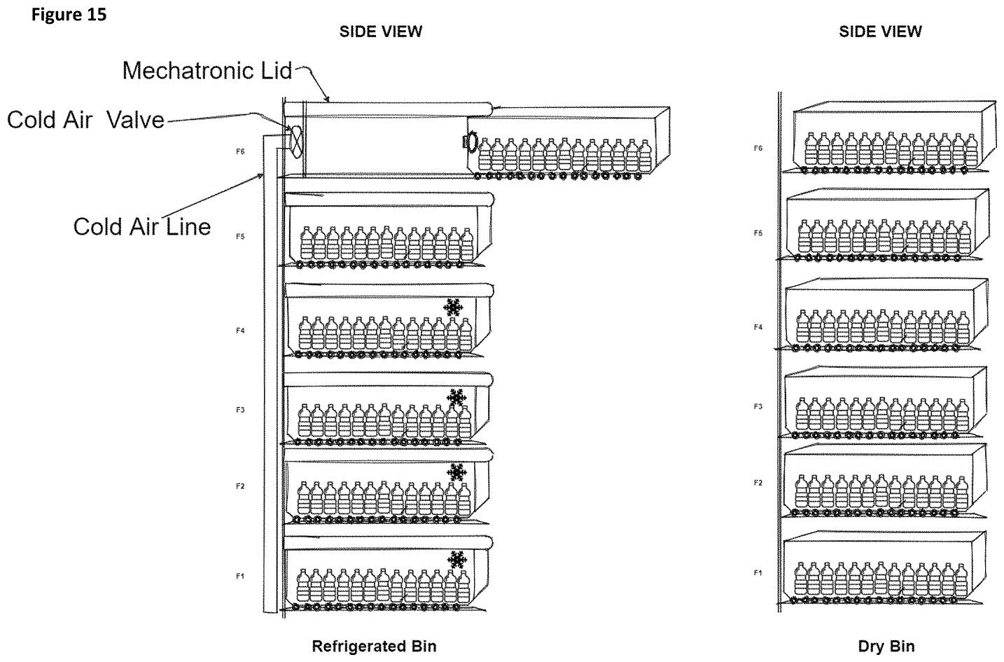

The container is comprised of two to three rows of mechatronic bins facing each other, where each row can have six floors, F1-F6, and 18 mechatronic bins, B1-B18, on each floor that automatically opens and closes upon robotic arm arrival. As stated above, there are two types of bins, dry and refrigerated. Refrigerated bins are fed with cold air flowing through the central ventilation system. Each refrigerated bin has a valve and a lid that is utilized upon opening and closing of the bin as shown in FIG. 15.

The container can consist of two main modules. Ordering module, where customers interact with a large touchscreen and AI based voice-activated display to place in-person orders as well as the dispensing module located on the opposite end of the container. These two main modules are separated by a large glass display window. Dispensing module consists of automatic doors and conveyor belts that dispense consumer purchases. On the rear side of the container there are also two sections, service area entrance door and automatic restocking section. On top of the container there are multiple solar panels along with built-in electric motors and solar sensors that tilt solar panels by tracking the sun light.

Although the present disclosure has been described with reference to the preferred embodiment thereof, it is apparent to those skilled in the art that a variety of modifications and changes may be made without departing from the scope of the present disclosure which is intended to be defined by the appended claims.

What is claimed is:

1. A convenience store system automated to select, package and dispense objects comprising:
a storage container modified to house machinery, electronics, access ports and hatches, power distribution and generation components;
the storage container is also designed to either dispense objects such as groceries, drinks, lottery tickets, currency or its equivalent, medication and food items or to receive objects such as recyclables, medication, currency or its equivalent;
the machinery incorporates conveyor belts, robotic arms, pneumatic manipulators, an shelf lifts to process delivery of objects contained within the storage container; and
the storage container can also contain a liquid dispensing apparatus incorporating pumps, reservoirs, mixers, injection nozzles and cup lid sealers.

2. A method of operating an automated object selection, packaging and dispensing system comprising the steps of:
inputting user selected items for delivery by a patron or its agent;
authenticating the user's information and processing the transaction;
the system initiating multiple subroutines for selecting the relevant item, packing the item and preparing it for pickup or delivery;
dispensing the relevant items at a pick-up location and/or to robotic unit or drone unit designated areas; and
alerting the user that the ordered items are ready to be picked up or are en-route to be delivered;

3. A hermetically sealed cup comprising;
a semi-conical cup with double walled construction for keeping dispensed liquids in a state of steady temperature;
the semi-conical cup is sealed at the top with a membrane that has perforated section for allowing the liquid to be sipped from once the perforated section is opened; and
the membrane is capable of being punctured by a nozzle injection system for dispensing drinks within the semi-conical cup.
